(19) United States
(12) Patent Application Publication
(10) Pub. No.: US 2026/0251844 A1
(43) Pub. Date: Aug. 27, 2026

(54) OPTICAL WAVEGUIDE DEVICE

(71) Applicant: SHINKO ELECTRIC INDUSTRIES CO., LTD., Nagano (JP)

(72) Inventor: Masaki MATSUMOTO, Nagano (JP)

(21) Appl. No.: 19/545,937

(22) Filed: Feb. 20, 2026

(30) Foreign Application Priority Data
Feb. 26, 2025 (JP) 2025-029318

(51) Int. Cl. G02B 6/12; G02B 6/13

(52) U.S. Cl. CPC G02B 6/12002; G02B 6/13; G02B 2006/12038; G02B 2006/12073; G02B 2006/12076; G02B 2006/12097; G02B 2006/121

(57) ABSTRACT

A first waveguide includes a lower cladding layer, a first core, and an upper cladding layer. The upper cladding layer includes a first surface on which a second waveguide is disposed, a second surface located closer to the lower cladding layer than the first surface and overlapping with the first core in plan view, and recesses located between the first surface and the second surface in plan view. The second waveguide includes a second core and a third cladding layer covering the second core. An edge area of a lower surface of the third cladding layer is in contact with the first surface. A region of the third cladding layer where the second core resides is located on the second surface via an adhesive layer. The second core overlaps with the first core in plan view and is optically coupled to the first core.

### CROSS-REFERENCE TO RELATED APPLICATIONS

The present application is based on and claims priority to Japanese Patent Application No. 2025-029318 filed on Feb. 26, 2025, with the Japanese Patent Office, the entire contents of which are incorporated herein by reference.

### FIELD

The disclosures herein relate to optical waveguide devices.

### BACKGROUND

As is known in the art, a technique exists for forming adiabatic coupling by aligning a polymer waveguide formed on a polymer and a silicon waveguide formed on a silicon chip. The polymer waveguide and the silicon waveguide are coupled via an adhesive layer for refractive index matching (for example, see Patent Document 1).

In adiabatic coupling, controlling the thickness of the adhesive layer is essential. However, the configuration of Patent Document 1 lacks the control mechanism for an excess adhesive constituting the adhesive layer. This gives rise to a risk that the thickness of the adhesive layer varies due to the excess or deficiency of the adhesive, thereby affecting the coupling characteristics.

### Related-Art Document

### Patent Document

[Patent Document 1] Japanese Laid-open Patent Publication No. 2014-81587

### SUMMARY

According to an aspect of the embodiment, an optical waveguide device includes a first waveguide and a second waveguide disposed on the first waveguide, wherein the first waveguide includes a lower cladding layer, a first core disposed on the lower cladding layer, and an upper cladding layer disposed on the lower cladding layer and covering the first core, wherein the upper cladding layer includes a first surface on which the second waveguide is disposed, a second surface located closer to the lower cladding layer than the first surface in cross-sectional view and overlapping with the first core in plan view, and one or more recesses located between the first surface and the second surface in plan view and recessed relative to the second surface in cross-sectional view, and wherein the second waveguide includes a second core and a third cladding layer covering the second core, an edge area of a lower surface of the third cladding layer is in contact with the first surface, a region of the third cladding layer where the second core resides is located on the second surface via an adhesive layer, and the second core overlaps with the first core in plan view and is optically coupled to the first core.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating an example of an optical waveguide device according to a first embodiment;

FIGS. 2A and 2B are cross-sectional views illustrating the example of the optical waveguide device according to the first embodiment;

FIGS. 3A through 3C are drawings illustrating an example of a manufacturing process of the optical waveguide device according to the first embodiment;

FIGS. 4A through 4C are drawings illustrating the example of the manufacturing process of the optical waveguide device according to the first embodiment;

FIG. 5 is a plan view illustrating an example of usage of the optical waveguide device according to the first embodiment; and

FIG. 6 is a cross-sectional view illustrating the example of usage of the optical waveguide device according to the first embodiment.

### DESCRIPTION OF EMBODIMENTS

Embodiments of the invention will be described below with reference to the accompanying drawings. In these drawings, the same components are denoted by the same reference numerals, and duplicate descriptions may be omitted.

### First Embodiment

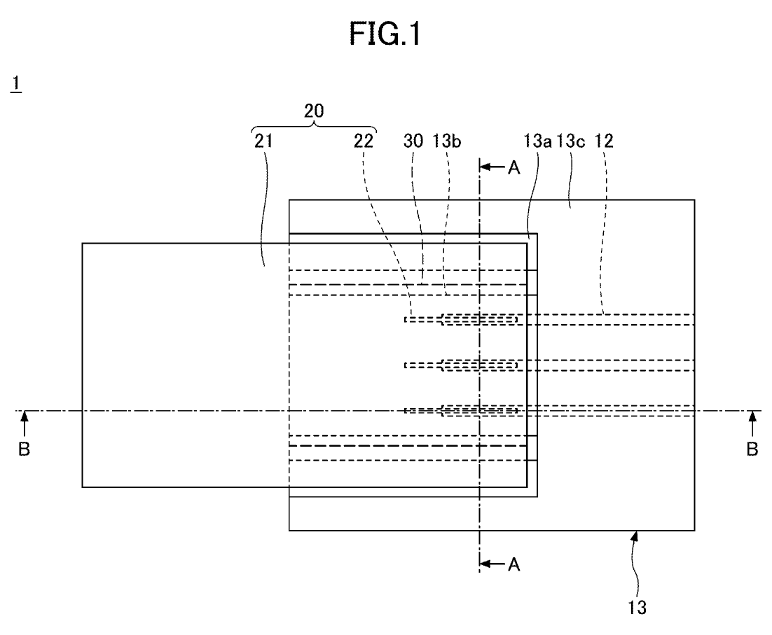

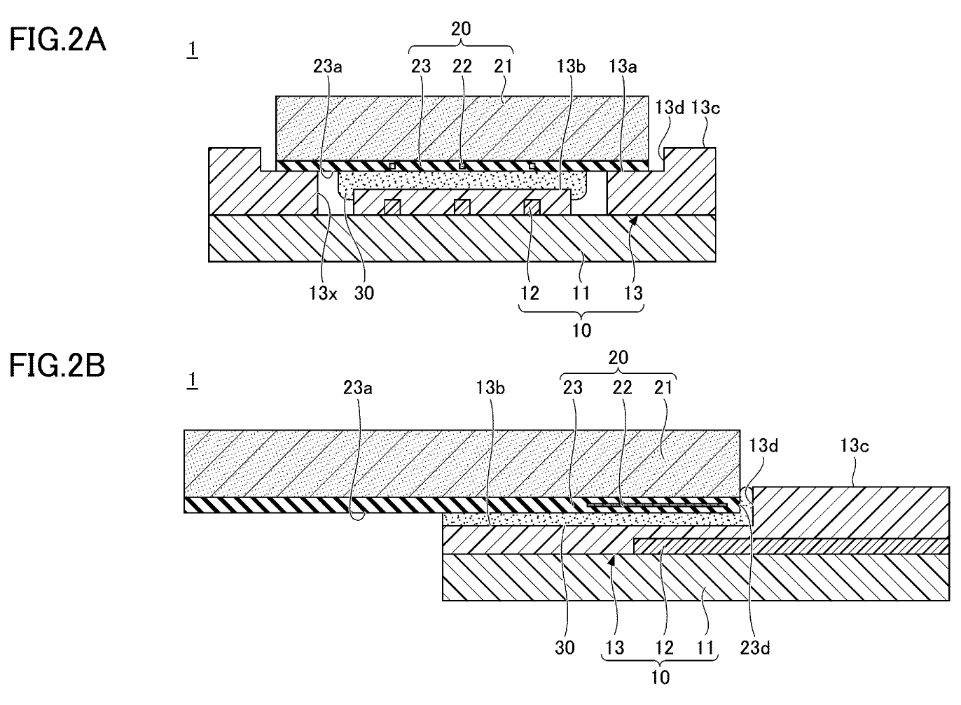

FIG. 1 is a plan view illustrating an example of an optical waveguide device according to a first embodiment. FIGS. 2A and 2B are cross-sectional views illustrating the example of the optical waveguide device according to the first embodiment. FIG. 2A is a cross-sectional view taken along line A-A in FIGS. 1 and 2B is a cross-sectional view taken along line B-B in FIG. 1. Referring to FIG. 1 and FIGS. 2A and 2B, an optical waveguide device 1 includes a first waveguide 10, a second waveguide 20 disposed on the first waveguide 10, and an adhesive layer 30.

The first waveguide 10 includes a lower cladding layer 11, a first core 12, and an upper cladding layer 13.

The thickness of the lower cladding layer 11 may be, for example, in the range of approximately 10 μm to 30 μm. The refractive index of the lower cladding layer 11 may be, for example, about 1.5. The lower cladding layer 11 is formed of, for example, a resin. Examples of the resin include photosensitive resins such as polyimide resins, acrylic resins, epoxy resins, polyolefin resins, and polynorbornene resins.

The first core 12 is disposed on the lower cladding layer 11. The number of first cores 12 may be 1 or more than 1. In the illustrated example, three first cores 12 are arranged side by side on the lower cladding layer 11 at predetermined intervals. The first cores 12 may be linear or may include curved portions. The intervals between the first cores 12 may or may not be constant.

The first cores 12 are arranged parallel to each other, for example. The width of each of the first cores 12 may be in the range of approximately 2 μm to 10 μm, for example. The thickness of each of the first cores 12 may be in the range of approximately 2 μm to 10 μm, for example. The refractive index of each of the first cores 12 is higher than those of the lower cladding layer 11 and the upper cladding layer 13, and may be about 1.6, for example. The first cores 12 are formed of, for example, resin, glass, silicon or a compound thereof (SiN, SiOₓ). The first cores 12 may be formed of, for example, a material selected as appropriate from those listed as examples of the material of the lower cladding layer 11.

The upper cladding layer 13 is disposed on the lower cladding layer 11 and covers the first cores 12. The thickness of the thickest portion of the upper cladding layer 13 may be, for example, in the range of approximately 10 μm to 30 μm. The thickness of the upper cladding layer 13 directly above the upper surface of the first cores 12 may be, for example, in the range of approximately 1 μm to 3 μm. The refractive index of the upper cladding layer 13 may be, for example, about 1.5. The upper cladding layer 13 is formed of, for example, resin. The upper cladding layer 13 may be formed of, for example, a material selected as appropriate from those listed as examples of the material for the lower cladding layer 11.

The upper cladding layer 13 has a first surface 13a on which the second waveguide 20 is disposed, and a second surface 13b which is located closer to the lower cladding layer 11 than the first surface 13a in cross-sectional view and overlaps the first core 12 in plan view. The difference in height between the first surface 13a and the second surface 13b may be, for example, in the range of approximately 0.5 μm to 2 μm. The upper cladding layer 13 has one or more recesses 13x which are located between the first surface 13a and the second surface 13b in plan view and are recessed relative to the second surface 13b in cross-sectional view.

Preferably, the upper cladding layer 13 has a third surface 13c which is located farther from the lower cladding layer 11 than the first surface 13a in cross-sectional view and located outside the first surface 13a in plan view, and an inner surface 13d which connects the third surface 13c with the first surface 13a and the second surface 13b. The difference in height between the first surface 13a and the third surface 13c may be, for example, in the range of approximately 10 μm to 30 μm.

In the illustrated example, the first surface 13a includes two regions which are disposed opposite each other across the second surface 13b in plan view. The upper cladding layer 13 has two recesses 13x which are each located between the second surface 13b and a corresponding one of the regions constituting the first surface 13a in plan view. Alternatively, the upper cladding layer 13 may have only one of the two recesses 13x. Further alternatively, the upper cladding layer 13 may include three or more recesses 13x. The recesses 13x may or may not penetrate the upper cladding layer 13.

In the illustrated example, the recesses 13x penetrate the upper cladding layer 13, and the bottom surface of the recesses 13x is formed by the top surface of the lower cladding layer 11. This structure effectively provides deeper recesses 13x, which are able to accommodate a larger portion of the adhesive layer 30 when a part of the adhesive layer 30 enters the recesses 13x, as described later.

The second waveguide 20 includes a substrate 21, second cores 22, and a cladding layer 23. The second waveguide 20 is, for example, a SiN waveguide. The second waveguide 20 may be a silicon waveguide, a glass waveguide, or a polymer waveguide. The second waveguide 20 may be a part of a planar lightwave circuit (PLC). Hereinafter, an example in which the second waveguide 20 is a silicon waveguide will be described.

The substrate 21 is a silicon substrate. The thickness of the substrate 21 is, for example, in the range of approximately 100 μm to 800 μm. The second cores 22 are fine optical waveguides and are disposed on one side of the substrate 21. The number of second cores 22 may be 1 or more than 1. In the illustrated example, three second cores 22 are arranged side by side at predetermined intervals on one side of the substrate 21. The second cores 22 may be linear or may include curved portions. The intervals between the adjacent second cores 22 may or may not be constant.

The second cores 22 are arranged parallel to each other, for example. The width of each of the second cores 22 may be in the range of approximately 200 nm to 500 nm, for example. Each second core 22 may be configured such that a region optically coupled to a corresponding one of the first core 12 has a tapered shape with its width gradually narrowing in plan view. The thickness of each of the second cores 22 may be in the range of approximately 20 nm to 300 nm, for example. The refractive index of the second cores 22 is higher than that of the cladding layer 23, and may be about 3.5, for example. The second cores 22 are formed of silicon, for example. The material of the second cores 22 is not limited to silicon, and silicon nitride, gallium arsenide, lithium niobate, or the like may be used instead of silicon.

The cladding layer 23 covers the second cores 22. The cladding layer 23 may be formed of a silicon oxide film (SiO₂, SiO_{X}, or the like), for example. The thickness of the cladding layer 23 may be, for example, in the range of approximately 2 μm to 6 μm. The refractive index of the cladding layer 23 may be, for example, about 1.5. The lower surface 23a of the cladding layer 23 is flat. In other words, a recess-protrusion structure as illustrated in Patent Document 1 is not formed on the lower surface 23a of the cladding layer 23.

Edge areas of the lower surface 23a of the cladding layer 23 are in contact with the first surface 13a of the upper cladding layer 13. The edge areas of the lower surface 23a of the cladding layer 23 and the first surface 13a of the upper cladding layer 13 are in direct contact with each other, without an adhesive layer or the like disposed in between. A region of the cladding layer 23 where the second cores 22 are disposed is located on the second surface 13b via the adhesive layer 30. The second cores 22 overlap with the first cores 12 in plan view and are optically coupled with the first cores 12. The optical coupling between the first cores 12 and the second cores 22 is adiabatic coupling.

The adhesive layer 30 fills the space between the second surface 13b of the upper cladding layer 13 and the lower surface 23a of the cladding layer 23. Some of the adhesive layer 30 protrude from the space between the second surface 13b and the lower surface 23a, thereby being located in the recesses 13x. The thickness of the adhesive layer 30 located between the second surface 13b and the lower surface 23a is equal to the difference in height between the first surface 13a and the second surface 13b of the upper cladding layer 13, and the remaining portion of the adhesive layer 30 resides in the recesses 13x. The thickness of the adhesive layer 30 between the second surface 13b and the lower surface 23a may be, for example, in the range of approximately 0.5 μm to 2 μm.

A part of the adhesive layer 30 preferably protrudes from the space between the second surface 13b and the lower surface 23a and resides between the inner surface 13d of the upper cladding layer 13 and a side surface 23d of the cladding layer 23. This effectively suppresses leakage of light from the cladding layer 23 during propagation through the second cores 22. That is, if air existed between the inner surface 13d of the upper cladding layer 13 and the side surface 23d of the cladding layer 23, a discontinuity in refractive index would occur because of the lower refractive index of air than that of the cladding layer 23, thereby inducing scattering loss or radiation loss . Since a part of the adhesive layer 30 is located between the inner surface 13d of the upper cladding layer 13 and the side surface 23d of the cladding layer 23, a discontinuity in refractive index is effectively suppressed.

The adhesive layer 30 is preferably an optical adhesive having good optical transparency, precise refractive index matching, and the like. Examples of the optical adhesive include, for example, an ultraviolet curable adhesive containing an epoxy-based resin as a main component. A thermosetting adhesive containing an epoxy-based resin as a main component may be used as the optical adhesive.

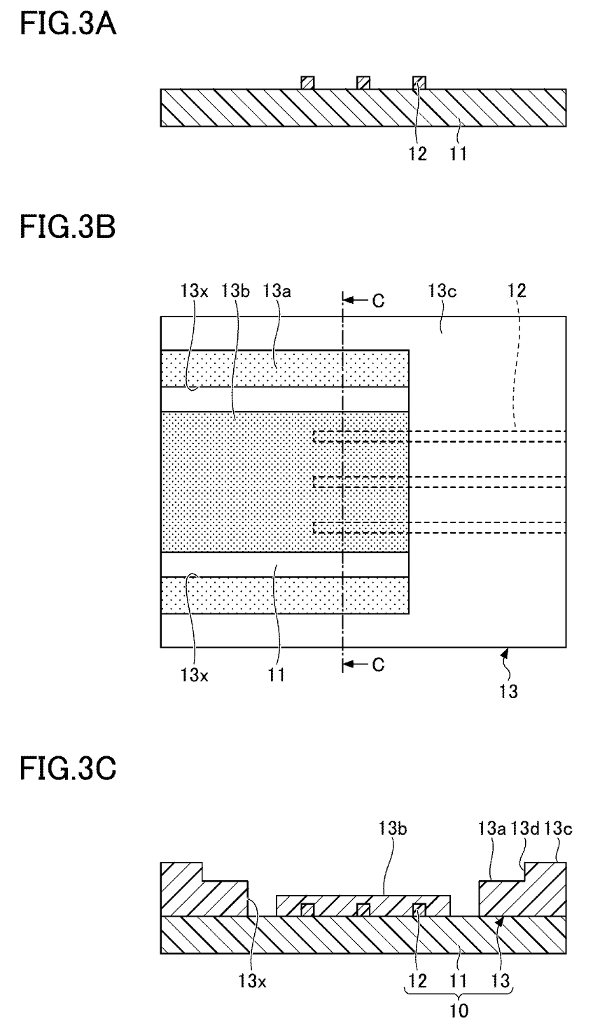

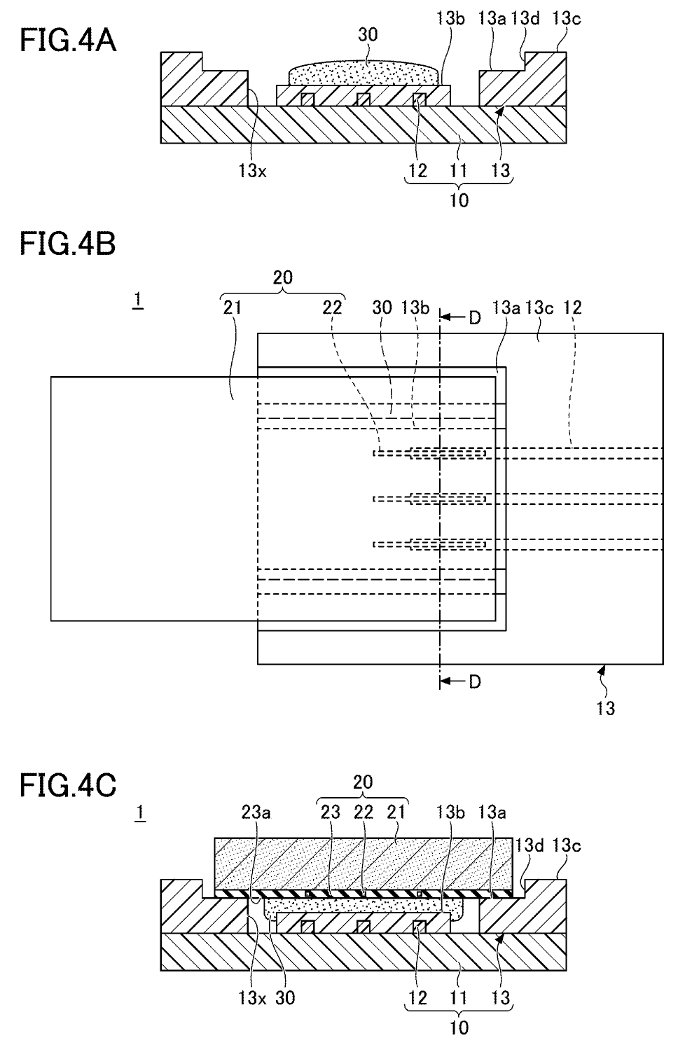

FIGS. 3A through 3C and FIGS. 4A through 4C are drawings illustrating an example of a manufacturing process of the optical waveguide device according to the first embodiment. To manufacture the optical waveguide device 1, first, as illustrated in FIG. 3A, a lower cladding layer 11 made of, for example, a photosensitive resin film is prepared, and a plurality of elongated first cores 12 are formed in a laterally spaced arrangement on the lower cladding layer 11. Specifically, a photosensitive resin for forming the first cores 12 is disposed on the lower cladding layer 11. The photosensitive resin is then developed by irradiation with ultraviolet light through a photomask, followed by being cured by heat.

Next, as illustrated in FIGS. 3B and 3C, an upper cladding layer 13 for covering the first cores 12 is formed on the lower cladding layer 11, thereby forming a first waveguide 10. FIG. 3B is a plan view, and FIG. 3C is a cross-sectional view taken along line C-C in FIG. 3B.

The upper cladding layer 13 may be formed, for example, by an imprint method. Specifically, a resin material covering the first cores 12 is disposed on the lower cladding layer 11, and the resin material is softened by heating or the like to form a resin layer. Further, a mold that has a surface profile conforming to the desired shape of the upper cladding layer 13 is prepared. The prepared mold is pressed against the softened resin layer to transfer the surface profile to the resin layer. The resin layer is cured by heating or ultraviolet irradiation to form the upper cladding layer 13 having the desired shape as a monolithic structure. Using the imprint method allows the upper cladding layer 13 to be formed by a simple manufacturing process and with a small dimensional error. For example, the process achieves an accuracy of ±1 μm or less for the difference in height between the first surface 13a and the second surface 13b.

The method of forming the upper cladding layer 13 is not limited to the method of monolithically forming the upper cladding layer by the imprint method, and any other method may be used. For example, a first resin film of a predetermined shape having a surface to be the first surface 13a, a second resin film of a predetermined shape having a surface to be the second surface 13b, and a third resin film of a predetermined shape having a surface to be the third surface 13c may be prepared. Then, the second resin film and the third resin film may be sequentially laminated on the first resin film and bonded to form the upper cladding layer 13. Alternatively, a resin material in liquid or paste form may be used instead of resin films.

As illustrated in FIG. 4A, an adhesive is applied to the second surface 13b of the upper cladding layer 13 to form an adhesive layer 30. At this point, the adhesive layer 30 is not cured. The adhesive may be applied, for example, by a dispenser, an inkjet or the like.

As illustrated in FIGS. 4B and 4C, a second waveguide 20 including a substrate 21, second cores 22 and a cladding layer 23 is prepared. The second waveguide 20 is disposed on the first waveguide 10 via the uncured adhesive layer 30, and then the uncured adhesive layer 30 is cured. FIG. 4B is a plan view, and FIG. 4C is a cross-sectional view taken along line D-D in FIG. 4B.

Specifically, the second waveguide 20 is disposed on the first waveguide 10 such that the edge areas of the lower surface 23a of the cladding layer 23 are in direct contact with the first surface 13a of the upper cladding layer 13, and the region of the cladding layer 23 where the second cores 22 reside is located directly above the second surface 13b via the adhesive layer 30. At this time, an excess adhesive portion of the uncured adhesive layer 30 is forced out of the space between the second surface 13b and the lower surface 23a to enter the recesses 13x. Preferably, as illustrated in FIG. 2B, the excess adhesive portion of the uncured adhesive layer 30 forced out of the space between the second surface 13b and the lower surface 23a also enters the space between the inner surface 13d of the upper cladding layer 13 and the side surface 23d of the cladding layer 23.

After the second waveguide 20 is disposed on the first waveguide 10 via the uncured adhesive layer 30, the uncured adhesive layer 30 is cured by heating or ultraviolet irradiation. As a result, the second cores 22 of the second waveguide 20 overlap with the first cores 12 of the first waveguide 10 in plan view for optical couplings with the first cores 12. By following these steps, the optical waveguide device 1 is fabricated.

As described above, the optical waveguide device 1 is configured such that the thickness of the adhesive layer 30 positioned between the second surface 13b and the lower surface 23a and affecting the optical coupling between the first cores 12 and the second cores 22 may be mechanically controlled in accordance with the difference in height between the first surface 13a and the second surface 13b relative to the upper surface of the lower cladding layer 11.

This arrangement effectively reduces variation in the thickness of the adhesive layer 30 regardless of the amount of the adhesive applied for forming the adhesive layer 30. For example, the thickness of the adhesive layer 30 positioned between the second surface 13b and the lower surface 23a may be controlled to be in the range of approximately 0.5 μm to 2 μm. Reducing variation in the thickness of the adhesive layer 30 enables the stabilization of the coupling efficiency between the first cores 12 and the second cores 22.

Moreover, during the formation of the adhesive layer 30, the excess adhesive is forced out of the space between the second surface 13b and the lower surface 23a to enter the recesses 13x. This arrangement effectively suppresses the risk of the excess adhesive affecting the thickness of the adhesive layer 30 located between the second surface 13b and the lower surface 23a.

Further, the structure of the optical waveguide device 1 is such that the lower surface 23a of the cladding layer 23 in the second waveguide 20 is flat. A recess-protrusion structure such as the structure of Patent Document 1 does not need to be provided by processing the optical waveguide. As a result, a general-purpose optical waveguide may be selected as the second waveguide 20, which is advantageous in terms of cost. Further, the optical waveguide device 1 does not have an engagement structure as in Patent Document 1, which increases the degree of freedom in selecting the structure and mounting method of the first waveguide 10 and the second waveguide 20.

Further, the first cores 12 in the optical waveguide device 1 are covered with the upper cladding layer 13 at all times, including during the manufacture of the optical waveguide device 1, thereby being less susceptible to external influences. For example, this arrangement effectively suppresses a yield drop that would be caused if the first cores 12 were under a mechanical load or had foreign matter adhering thereto.

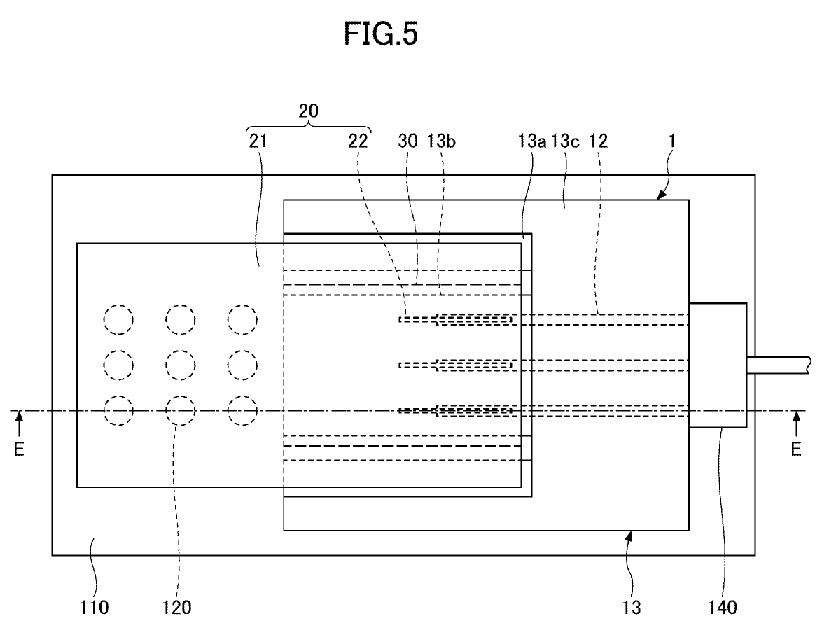

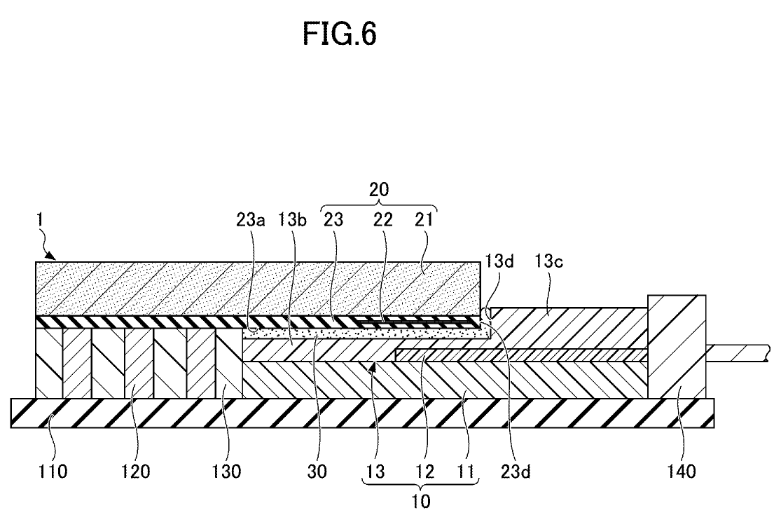

FIG. 5 is a plan view illustrating an example of usage of the optical waveguide device according to the first embodiment; and FIG. 6 is a cross-sectional view illustrating the example of usage of the optical waveguide device according to the first embodiment, and illustrates a cross-sectional view along line E-E in FIG. 5.

As illustrated in FIGS. 5 and 6, the optical waveguide device 1 may be mounted on an interconnect substrate 110 when used. The interconnect substrate 110 may be, for example, any interconnect substrate such as a build- up substrate, a substrate with built-in electronic components, a silicon substrate, a ceramic substrate, or the like.

The electrodes of the interconnect substrate 110 and the electrodes of the second waveguide 20 may be electrically connected via columnar electrodes 120 made of, for example, copper or the like. A resin portion 130 covering the columnar electrodes 120 may fill the space across which the interconnect substrate 110 and the second waveguide 20 face each other.

In the illustrated example, a fiber array 140 is mounted on the interconnect substrate 110. The fiber array 140 is arranged on the interconnect substrate 110 so as to face the end face of the first waveguide 10. Specifically, the fiber array 140 includes optical fibers and is positioned such that the center axes of the cores of these optical fibers align with the center axes of the first cores 12 of the first waveguide 10. This establishes optical couplings. The fiber array 140 may be fixed to the interconnect substrate 110 with, for example, an adhesive.

An optical adhesive is preferably disposed between the opposing surfaces of the fiber array 140 and the first waveguide 10. This arrangement effectively prevents air reflection, thereby enhancing the coupling efficiency between the optical fiber cores of the fiber array 140 and the first cores 12 of the first waveguide 10. The optical adhesive is as previously described.

An electronic component electrically connected to the optical waveguide device 1 may be disposed on the interconnect substrate 110. The electronic component may be, for example, an IC chip incorporating a digital signal processor (DSP) for processing output signals from the optical waveguide device 1, an amplifier, or the like.

According to at least one embodiment, an optical waveguide device exhibits reduced variation in the thickness of an adhesive layer for optically coupling a first waveguide and a second waveguide.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical waveguide device comprising:
a first waveguide; and
a second waveguide disposed on the first waveguide,
wherein the first waveguide includes:
a lower cladding layer;
a first core disposed on the lower cladding layer; and
an upper cladding layer disposed on the lower cladding layer and covering the first core,
wherein the upper cladding layer includes:
a first surface on which the second waveguide is disposed;
a second surface located closer to the lower cladding layer than the first surface in cross-sectional view and overlapping with the first core in plan view; and
one or more recesses located between the first surface and the second surface in plan view and recessed relative to the second surface in cross-sectional view, and
wherein the second waveguide includes a second core and a third cladding layer covering the second core,
an edge area of a lower surface of the third cladding layer is in contact with the first surface,
a region of the third cladding layer where the second core resides is located on the second surface via an adhesive layer, and
the second core overlaps with the first core in plan view and is optically coupled to the first core.

2. The optical waveguide device according to claim 1, wherein the upper cladding layer further includes a third surface which is located farther from the lower cladding layer than the first surface in cross-sectional view, and which is located outside the first surface in plan view.

3. The optical waveguide device according to claim 2, wherein the upper cladding layer further includes an inner surface connecting the third surface and the second surface, and a part of the adhesive layer is located between the inner surface and a side surface of the third cladding layer.

4. The optical waveguide device according to claim 1, wherein a part of the adhesive layer is located in the one or more recesses.

5. The optical waveguide device according to claim 1, wherein the lower surface of the third cladding layer is flat.

6. The optical waveguide device according to claim 1, wherein a bottom surface of the one or more recesses is an upper surface of the lower cladding layer.

7. The optical waveguide device according to claim 1, wherein the upper cladding layer includes a plurality of said recesses.

8. The optical waveguide device according to claim 1, wherein the upper cladding layer is formed as a monolithic structure.

9. The optical waveguide device according to claim 1, wherein the first core, the lower cladding layer, and the upper cladding layer are formed of resin.

10. The optical waveguide device according to claim 9, wherein the second core is formed of silicon, and the third cladding layer is formed of a silicon oxide film.
